(19) United States
(12) Patent Application Publication
(10) Pub. No.: US 2026/0065638 A1
(43) Pub. Date: Mar. 5, 2026

(54) NON-ITERATIVE CLUSTERING FOR HIGH-RESOLUTION BINARY IMAGES

(71) Applicant: Synaptics Incorporated, San Jose, CA (US)

(72) Inventors: Ran Zvi Bezen, Ramat Gan (IL); Dmitri Lvov, Ramat Hasharon (IL)

(73) Assignee: Synaptics Incorporated, San Jose, CA (US)

(21) Appl. No.: 18/816,762

(22) Filed: Aug. 27, 2024

(51) Int. Cl. G06V 10/762; G06T 7/246; G06V 10/26; G06V 20/70

(52) U.S. Cl. CPC G06V 10/762; G06T 7/248; G06V 10/267; G06V 20/70

(57) ABSTRACT

This disclosure provides methods, devices, and systems for image processing. The present implementations more specifically relate to systems and techniques for binary image processing. In some aspects, an image processing system downsamples an image as a grid of binary cells based on a pooling operation. In some implementations, the pooling operation is a max pooling operation. In some other aspects, the image processing system groups a subset of the binary cells into one or more contiguous regions of the grid based on a binary image clustering algorithm. In some implementations, the binary image clustering algorithm is a connected-component labeling (CCL) algorithm. In some other aspects, the image processing system determines a respective boundary for each of the one or more contiguous regions. In some other aspects, the image processing system maps the determined boundaries to the image. In some instances, the image is a binary motion map of an environment.

### TECHNICAL FIELD

The present implementations relate generally to image processing, and specifically to non-iterative clustering techniques for high-resolution binary images.

### BACKGROUND OF RELATED ART

Image processing focuses on the manipulation and analysis of images to enhance their quality and/or extract meaningful information. Image processing techniques are used in a wide range of applications, from medical imaging to autonomous vehicles. Some image processing techniques are used in computer vision, for example, to extract meaningful information and/or to detect objects in an image.

Image clustering is a computer vision technique for grouping images or parts of images based on shared or similar visual features. Existing clustering techniques, such as K-means and connected-component labeling (CCL), are generally complex and resource-intensive. In particular, K-means generally requires multiple iterations to converge on an optimal solution, and CCL generally requires several stages of operation to smooth object boundaries and remove noise in a high-resolution image. For instance, morphological operations, such as dilation (i.e., expanding the boundaries of foreground objects) and erosion (i.e., shrinking the boundaries), are often performed on the inputs of CCL operations.

Clustering operations performed on high-resolution images consume significant computational power and memory. Grouping pixels in high-resolution images with an unknown number of clusters is a particularly challenging task.

Many computer vision applications are implemented by low-power devices with limited memory and processing resources. Thus, there is a need for an effective and efficient solution for grouping pixels in high-resolution images with an unknown number of clusters.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of image processing. The method includes steps of downsampling an image as a grid of binary cells based on a pooling operation, grouping a subset of the binary cells into one or more contiguous regions of the grid based on a binary image clustering algorithm, determining a respective boundary for each of the one or more contiguous regions, and mapping the determined boundaries to the image.

Another innovative aspect of the subject matter of this disclosure can be implemented in an image processing system that includes a processing system and a memory. The memory stores instructions that, when executed by the processing system, cause the image processing system to perform operations including downsampling an image as a grid of binary cells based on a pooling operation, grouping a subset of the binary cells into one or more contiguous regions of the grid based on a binary image clustering algorithm, determining a respective boundary for each of the one or more contiguous regions, and mapping the determined boundaries to the image.

### BRIEF DESCRIPTION OF THE DRAWINGS

The present implementations are illustrated by way of example and are not intended to be limited by the figures of the accompanying drawings.

FIG. 1 shows a block diagram of an example image processing system, according to some implementations.

FIG. 2 shows a block diagram of an example image processing system, according to some implementations.

FIG. 3 shows a block diagram of an example image processing system, according to some implementations.

FIG. 4 shows an example image processing pipeline, according to some implementations.

FIG. 5 shows a block diagram of an example image processing system, according to some implementations.

FIG. 6 shows an illustrative flowchart depicting an example operation for image processing, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example image processing devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, image processing and computer vision techniques are generally complex and resource-intensive. In particular, K-means clustering generally requires multiple iterations, and connected-component labeling (CCL) generally requires several stages of operation on a high-resolution image. Furthermore, grouping pixels in high-resolution images with an unknown number of clusters is a particularly challenging task.

Pooling is an image processing (decimation) technique for reducing the dimensionality of an image by aggregating regions of the image to lower resolutions. In this manner, pooling can be used to extract prominent features from an image, such as to facilitate classification tasks or object detection tasks. Specifically, pooling operations involve partitioning an image into smaller, non-overlapping regions, each defined by a pooling window, or kernel (K), of size K×K. The pooling window slides across the image, typically with a stride of K, ensuring each region is processed once. In some instances, a different stride may be used and some regions may be processed more than once. For each region, the pooling operation applies an aggregation function, such as max pooling (selecting the maximum value), average pooling (calculating the mean), or other variations like min or L2-norm pooling. The result of the aggregation (the “representative value”) is assigned to a corresponding cell in a new, lower-resolution image or grid.

Aspects of the present disclosure recognize that pooling can be used to downsample high-resolution images, in a manner that achieves dilation and erosion in a single iteration, so that image clustering operations (such as CCL) can be performed more effectively and efficiently on high-resolution binary images having an unknown number of clusters.

Various aspects relate generally to image processing, and more particularly, to systems and techniques for processing binary images. For example, an image processing system may downsample an image as a grid of binary cells based on a pooling operation. In some implementations, the pooling operation is a max pooling operation. In some other implementations, the pooling operation is an average pooling operation, a min pooling operation, or another suitable pooling operation. As described above, max pooling is a type of pooling that selects the maximum value from each pooling region, thereby reducing size while preserving prominent features. In some implementations, the image has a height (H) and width (W) of relatively high resolution, and the grid of binary cells has a height (H/K) and width (W/K) of much lower resolution. It will be understood that the dimensions of the grid are smaller than the dimensions of the image and that the extent to which the dimensions are reduced is proportional to K. As a non-limiting example, if K is 100, the dimensions of the grid will be 100 times smaller than the dimensions of the image. In some instances, the number of pixels in the low-resolution grid of binary cells may be less than 1% of the number of pixels in the high-resolution image. The image processing system may group a subset of the binary cells into one or more contiguous regions (also referred to as “clusters”) of the grid based on a CCL algorithm. The image processing system may further determine a respective boundary for each of the clusters and map the boundaries to the image.

Particular implementations of the subject matter described in this disclosure can be implemented to realize one or more of the following potential advantages. By using a pooling operation to downsample a high-resolution image as a low-resolution grid of binary cells, close prominent pixels are combined into a single pixel at the lower resolution, thus connecting pixels that may not be connected in the high-resolution image. Performing CCL on the low-resolution grid of binary cells, rather than the high-resolution image, reduces processing and memory overhead while eliminating the need to apply dilation and erosion to a high-resolution image. By mapping the boundaries associated with the clusters to the high-resolution image, portions of the high-resolution image may be identified as regions of interest and used for various downstream tasks. As one example, the boundaries may be used to crop regions of interest from the high-resolution image, and an object detection algorithm may be used to analyze the cropped sections to identify one or more objects within the high-resolution image. This enables object detection to be performed on higher resolution image data and/or using less processing and memory resources.

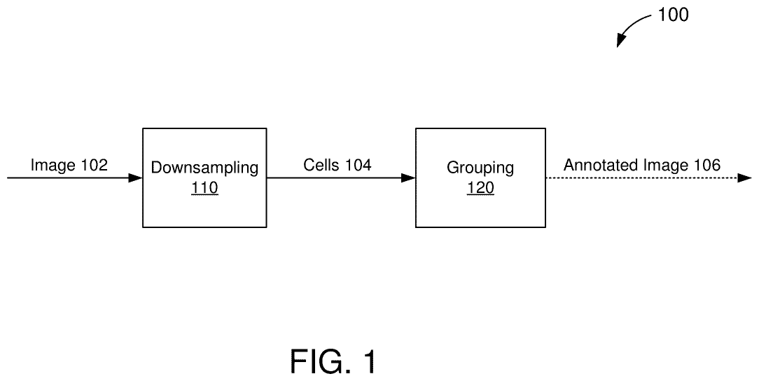

FIG. 1 shows a block diagram of an example image processing system 100, according to some implementations. In some aspects, the image processing system 100 may be configured to annotate an input image. The image processing system 100 includes a downsampling component 110 and a grouping component 120.

The downsampling component 110 receives an image 102 as input. The downsampling component 110 is configured to downsample the image 102 as a grid of cells 104. In some implementations, the downsampling component 110 may downsample the image 102 based on a pooling operation. Example suitable pooling operations include max pooling, min pooling, and average pooling, among other examples.

The grouping component 120 is configured to group a subset of the cells 104 into one or more contiguous regions (also referred to as “clusters”). A cluster may be any contiguous region of the grid having cells 104 that share the same label. In some aspects, the cells 104 may be grouped into clusters based on an image clustering operation, and a label may be a value or attribute assigned to a cell by the image clustering operation, where cells sharing the same label are deemed related or similar based on a labeling criterion (e.g., edge proximity) of the image clustering operation. Example suitable clustering techniques include K-means and connected-component labeling (CCL), among other examples. In some implementations, the grouping component 120 may produce an annotated image 106 based on the clusters.

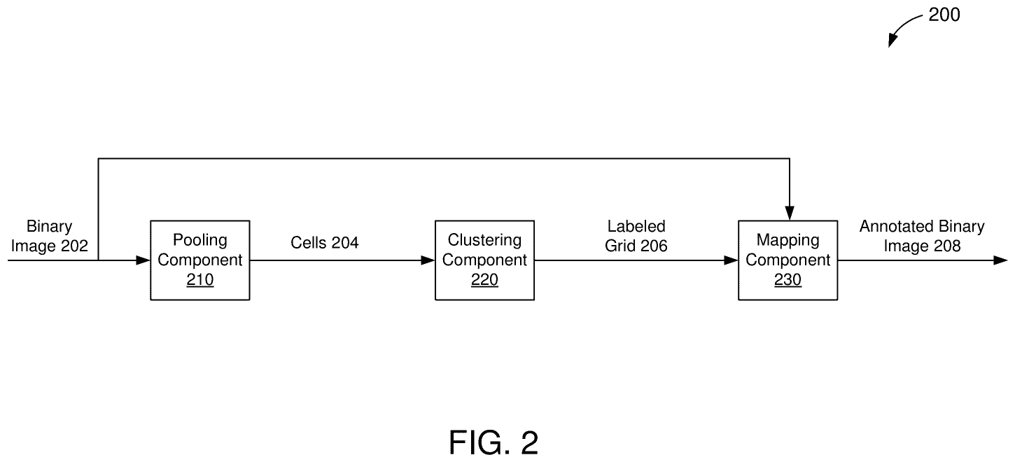

FIG. 2 shows a block diagram of an example image processing system 200, according to some implementations. The image processing system 200 may be one example of the image processing system 100 described with respect to FIG. 1. The image processing system 200 includes a pooling component 210, a clustering component 220, and a mapping component 230. In some implementations, the pooling component 210 and the clustering component 220 may be examples of the downsampling component 110 and the grouping component 120, respectively, of FIG. 1.

The pooling component 210 receives a binary image 202. In some implementations, the binary image 202 may be one example of the image 102 of FIG. 1. It will be understood that each pixel of the binary image 202 has one of two possible values (e.g., 1 or 0). In some implementations, the pooling component 210 may perform a pooling operation on the binary image 202. By performing a pooling operation on the binary image 202, the pooling component 210 generates a grid of binary cells 204, each having one of the two possible values (e.g., 1 or 0). The grid of binary cells 204 may be one example of the grid of cells 104 of FIG. 1.

The clustering component 220 is configured to perform an image clustering operation on the grid of binary cells 204. In some implementations, the clustering component 220 may implement a binary image clustering technique, such as connected-component labeling (CCL), which identifies relationships among the binary cells. For example, a relationship may be identified between two cells that each have a value of “1” and share a common edge or corner (i.e., the two cells are horizontally, vertically, or diagonally adjacent). In some implementations, CCL may identify a relationship between two cells that are close in proximity but not directly adjacent. The clustering component 220 may further group a subset of the binary cells into one or more clusters based on the identified relationships. Specifically, the clustering component 220 may label each binary cell 204 as belonging to (or not belonging to) a particular cluster.

The mapping component 230 is configured to perform a boundary detection operation on the labeled grid 206. In some implementations, the mapping component 230 may determine a respective boundary for each of the one or more contiguous regions based on the labels. The mapping component 230 may further map (or project) the determined boundaries onto the binary image 202, thereby producing an annotated binary image 208. In some implementations, the annotated binary image 208 may be one example of the annotated image 106 of FIG. 1.

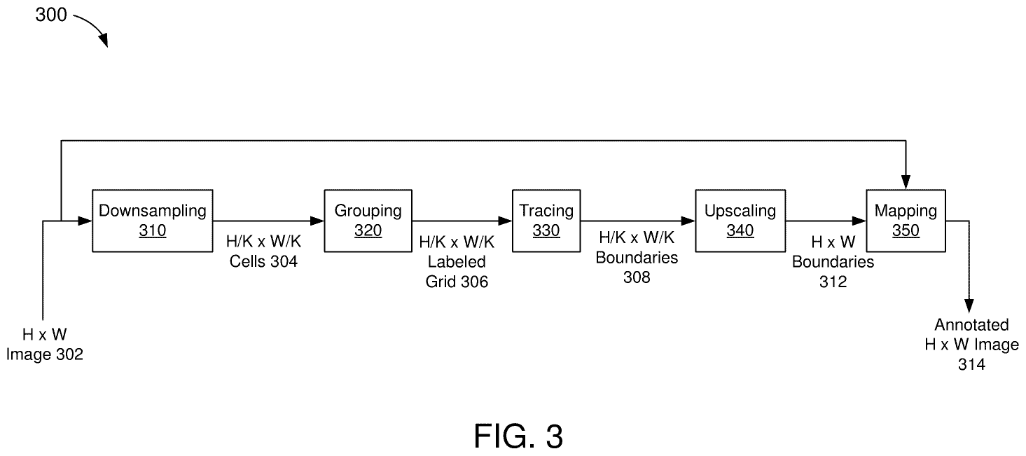

FIG. 3 shows a block diagram of an example image processing system 300, according to some implementations. The image processing system 300 may be one example of the image processing system 100 or the image processing system 200 described with respect to FIG. 1 and FIG. 2, respectively. The image processing system 300 includes a downsampling component 310, a grouping component 320, a tracing component 330, an upscaling component 340, and a mapping component 350. In some implementations, the downsampling component 310 and the grouping component 320 may be examples of the pooling component 210 and the clustering component 220, respectively, of FIG. 2. In some implementations, the tracing component 330, the upscaling component 340, and the mapping component 350 may be example subcomponents of the mapping component 230 of FIG. 2.

The downsampling component 310 is configured to receive an image 302 having a height (H) and a width (W). In some implementations, the image 302 may be one example of the binary image 202 of FIG. 2. In some implementations, the downsampling component 310 may perform a pooling operation to downsample the image 302 as a grid of cells 304 having a height H/K and a width W/K, where K is a kernel (or filter) size associated with the pooling operation. It will be understood that the dimensions of the grid of cells 304 are smaller than the dimensions of the image 302 and that the extent to which the dimensions are reduced is proportional to K. In some implementations, the grid of cells 304 may be one example of the grid of binary cells 204 of FIG. 2.

The grouping component 320 is configured to group a subset of the cells 304 into one or more clusters. Specifically, the grouping component 320 may label each of the cells 304 according to the cluster to which the cell is grouped (if any), thereby generating a labeled grid 306 with dimensions H/K×W/K. In some implementations, the labeled grid 306 may be one example of the labeled grid 206 of FIG. 2.

The tracing component 330 is configured to determine a respective boundary for each of the clusters of the labeled grid 306 to generate the H/K×W/K boundaries 308. In some implementations, the tracing component 330 may identify corner cells for each of the clusters and may draw a bounding box around the respective cluster. In some other implementations, the tracing component 330 may identify the corner cells based on the outermost cells possessing the respective label. For instance, the tracing component 330 may delineate the outermost (boundary) cells by examining each cell's nearest neighbors and classifying the cell as a boundary if the cell is adjacent to differently labeled cells. In such instances, the tracing component 330 may modify each boundary cell identified in the labeled grid 306, such as by setting a binary flag associated with the boundary cell.

The upscaling component 340 is configured to upscale (or project) the boundaries 308 to larger dimensions by adjusting them proportionally within the dimensions of H and W to generate the H×W boundaries 312. The upscaling (or projection) process may incorporate one or more aspects of interpolation (e.g., nearest neighbor, bilinear, or the like), adjusting pixel values proportionally, scaling or stretching boundary coordinates, or another suitable upscaling or projection technique.

The mapping component 350 may map (or overlay) the boundaries 312 onto the image 302 to produce an annotated image 314 having dimensions H×W. In other words, the annotated image 314 represents the image 302 overlayed with the boundaries 312. In some implementations, the annotated image 314 may be one example of the annotated binary image 208 of FIG. 2.

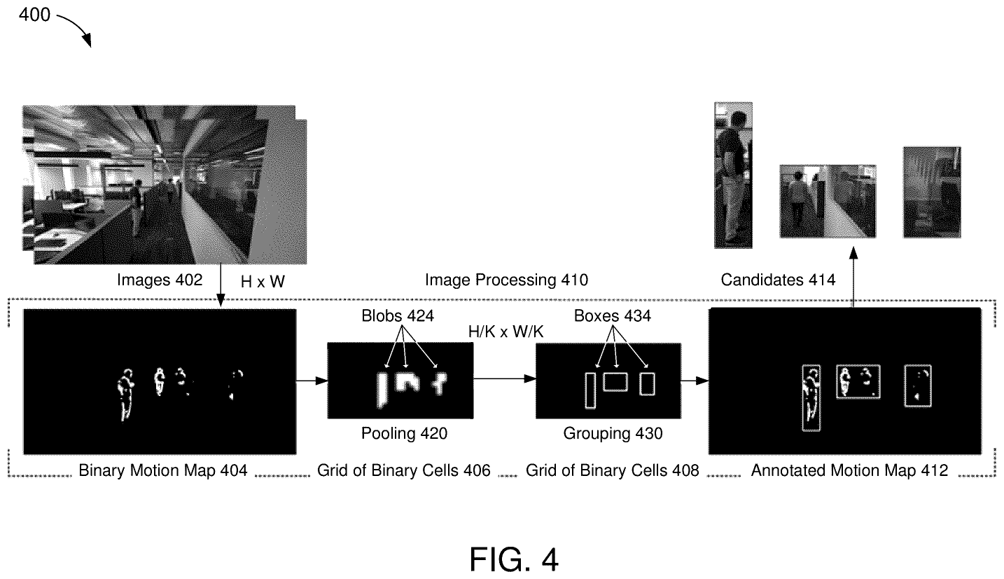

FIG. 4 shows an example image processing pipeline 400, according to some implementations. The pipeline 400 begins with capturing a series of images 402 of an environment (e.g., via a camera). The images 402 may have dimensions H×W (e.g., 1080×1920 pixels). In some implementations, the images 402 may be color images encoded in red-green-blue (RGB), Luminance-Bandwidth-Chrominance (YUV), cyan-yellow-magenta-key (CYMK), hue saturation value (HSV), or another suitable color space. In some implementations, a motion detection operation may convert the images 402 to a binary motion map 404 (also having dimensions H×W) based on changes or differences between two or more of the images 402. The binary motion map 404 may reduce every pixel of a representative one of the images 402 to a value of either 1 or 0. In some implementations, a pixel value of 1 may indicate motion detected based on changes or differences in pixel values between successive images or frames, and a pixel value of 0 may indicate no motion (e.g., a static portion of the environment). Accordingly, as shown in the binary motion map 404, active elements (e.g., moving people) appear as white outlines (i.e., where pixel values are equal to 1), and the other portions of the binary motion map 404 are shown in black (i.e., where pixel values are equal to 0). The binary motion map 404 may be provided to an image processing system, such as the image processing system 100 of FIG. 1, which may perform the steps of image processing 410.

In some implementations, the image processing system may perform a pooling operation 420 (e.g., max pooling) on the binary motion map 404. More specifically, the pooling operation 420 may be performed by the downsampling component 110 of FIG. 1, the pooling component 210 of FIG. 2, or the downsampling component 310 of FIG. 3. As shown in FIG. 4, the pooling operation produces a downsampled grid of binary cells 406 having dimensions H/K×W/K (e.g., 18×32 pixels). As shown in FIG. 4, the outlines of the active elements (e.g., moving people) shown in the binary motion map 404 are reduced to low-resolution blobs 424 (or “clumps”) in the downsampled image.

In some implementations, the image processing system may further perform a grouping operation 430 (e.g., connected-component labeling (CCL)) on the grid of binary cells 408. For example, performing CCL on an 18×32 binary grid (i.e., 576 pixels×1 channel=576 bits) requires substantially less computational resources and time than performing CCL on a 1080×1920 RGB image (i.e., 2,073,600 pixels×3 channels=49,766,400 bits). The grouping operation 430 may be performed by the grouping component 120 of FIG. 1, the clustering component 220 and the mapping component 230 of FIG. 2, or the grouping component 320 and the tracing component 330 of FIG. 3. As shown in FIG. 4, the grouping operation produces bounding boxes 434 (or “boundaries”) around connected clusters of the grid.

In some implementations, the image processing system may further generate an annotated motion map 412 based on the boundaries. For example, the image processing system may generate the annotated motion map 412 by upscaling (or projecting) the boundaries to larger dimensions by adjusting them proportionally within the dimensions H×W and mapping the upscaled boundaries onto the binary motion map 404. More specifically, such upscaling and mapping operations may be performed by the mapping component 230 of FIG. 2, or the upscaling component 340 and the mapping component 350 of FIG. 3. In some implementations, the annotated motion map 412 may be one example of the annotated image 106 of FIG. 1, the annotated binary image 208 of FIG. 2, or the annotated image 314 of FIG. 3.

In some implementations, portions of the annotated motion map 412 that are bounded by the mapped rectangles may be cropped from the annotated motion map 412. In such implementations, one or more image processing operations may be performed on each of the cropped portions. In some other implementations, the boundaries may be mapped to a representative one of the images 402, and portions of the original image that are bounded by the mapped rectangles may be cropped from the original image. As shown in FIG. 4, portions of one of the images 402 may be cropped based on the mapped boundaries and labeled as candidates 414, such as candidates (or “regions of interest”) for object detection. In some instances, multiple candidates may be grouped within a same boundary, such as when a minimum group (or boundary) size is set. In some implementations not shown, the candidates 414 may be fed to an object detection algorithm enabling the identification of one or more objects in the corresponding image 402. It will be appreciated that the cropped portions of the image will have a significantly smaller number of pixels than the total number of pixels of the entire image; accordingly, an amount of processing and time required by the object detection algorithm to identify the objects will be significantly reduced.

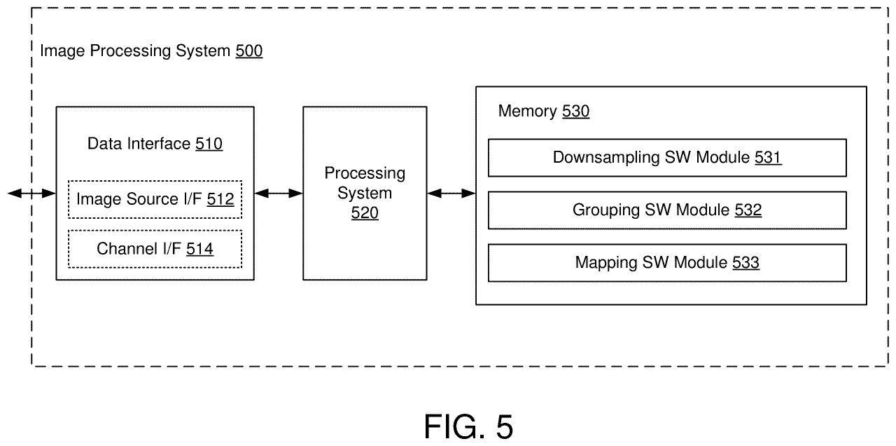

FIG. 5 shows a block diagram of an example image processing system 500, according to some implementations. In some implementations, the image processing system 500 may be one example of the image processing system 100 of FIG. 1.

The image processing system 500 includes a data interface 510, a processing system 520, and a memory 530. The data interface 510 is configured to receive an image from an image source over a communication channel. In some aspects, the data interface 510 may include an image source interface (I/F) 512 for communicating with the image source and a channel interface 514 for communicating over the communication channel.

The memory 530 may include a non-transitory computer-readable medium (including one or more nonvolatile memory elements, such as EPROM, EEPROM, Flash memory, a hard drive, and the like) that may store at least the following software (SW) modules:
a downsampling SW module 531 to downsample an image as a grid of binary cells based on a pooling operation;
a grouping SW module 532 to group a subset of the binary cells into one or more contiguous regions of the grid based on a binary image clustering algorithm; and
a mapping SW module 533 to determine a respective boundary for each of the one or more contiguous regions and map the determined boundaries to the image.
   Each software module includes instructions that, when executed by the processing system 520, cause the image processing system 500 to perform the corresponding functions.

The processing system 520 may include any suitable one or more processors capable of executing scripts or instructions of one or more software programs stored in the image processing system 500 (such as in the memory 530). For example, the processing system 520 may execute the downsampling SW module 531 to downsample an image as a grid of binary cells based on a pooling operation. The processing system 520 may execute the grouping SW module 532 to group a subset of the binary cells into one or more contiguous regions of the grid based on a binary image clustering algorithm. The processing system 520 may execute the mapping SW module 533 to determine a respective boundary for each of the one or more contiguous regions and map the determined boundaries to the image.

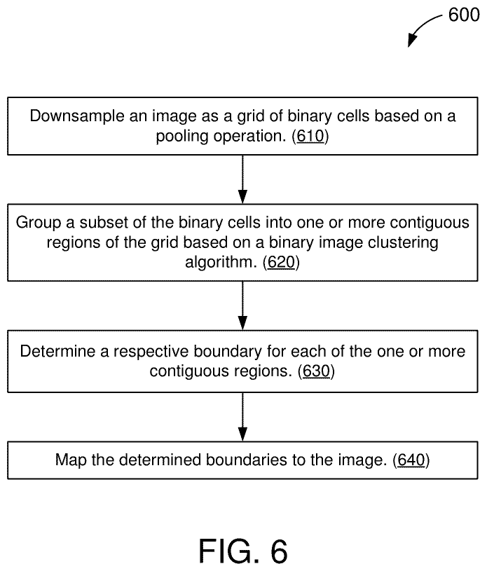

FIG. 6 shows an illustrative flowchart depicting an example operation 600 for image processing, according to some implementations. In some implementations, the example operation 600 may be performed by an image processing system such as the image processing system 100 of FIG. 1.

The image processing system downsamples an image as a grid of binary cells based on a pooling operation (610). The image processing system groups a subset of the binary cells into one or more contiguous regions of the grid based on a binary image clustering algorithm (620). The image processing system determines a respective boundary for each of the one or more contiguous regions (630). The image processing system maps the determined boundaries to the image (640).

In some implementations, the pooling operation is a max pooling operation. In some implementations, the binary image clustering algorithm is a connected-component labeling (CCL) algorithm. In some aspects, the image has a height (H) and a width (W) and the grid of binary cells has a height equal to H/K and a width equal to W/K, where K is a kernel size associated with the pooling operation. In some of such aspects, mapping the determined boundaries to the image includes upscaling the determined boundaries based on the H and the W of the image.

In some other implementations, the image is a binary motion map of an environment. In some of such implementations, the image processing system captures a series of images of the environment and generates the binary motion map based on changes between two or more images in the series of images. In some instances, the image processing system labels each of the mapped boundaries as a candidate for object detection.

In some implementations, the image processing system crops portions of the image that are bounded by the mapped boundaries and performs one or more image processing operations on each of the cropped portions of the image. In some of such implementations, the one or more image processing operations includes an object detection operation.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of image processing, comprising:
downsampling an image as a grid of binary cells based on a pooling operation;
grouping a subset of the binary cells into one or more contiguous regions of the grid based on a binary image clustering algorithm;
determining a respective boundary for each of the one or more contiguous regions; and
mapping the determined boundaries to the image.

2. The method of claim 1, wherein the pooling operation is a max pooling operation.

3. The method of claim 1, wherein the binary image clustering algorithm is a connected-component labeling (CCL) algorithm.

4. The method of claim 1, wherein the image has a height (H) and a width (W) and the grid of binary cells has a height equal to H/K and a width equal to W/K, where K is a kernel size associated with the pooling operation.

5. The method of claim 4, wherein mapping the determined boundaries to the image includes:
upscaling the determined boundaries based on the H and the W of the image.

6. The method of claim 1, wherein the image is a binary motion map of an environment.

7. The method of claim 6, further comprising:
capturing a series of images of the environment; and
generating the binary motion map based on changes between two or more images in the series of images.

8. The method of claim 7, further comprising:
labeling each of the mapped boundaries as a candidate for object detection.

9. The method of claim 1, further comprising:
cropping portions of the image that are bounded by the mapped boundaries; and
performing one or more image processing operations on each of the cropped portions of the image.

10. The method of claim 9, wherein the one or more image processing operations includes an object detection operation.

11. An image processing system, comprising:
a processing system; and
a memory storing instructions that, when executed by the processing system, causes the image processing system to perform operations including:
downsampling an image as a grid of binary cells based on a pooling operation;
grouping a subset of the binary cells into one or more contiguous regions of the grid based on a binary image clustering algorithm;
determining a respective boundary for each of the one or more contiguous regions; and
mapping the determined boundaries to the image.

12. The image processing system of claim 11, wherein the pooling operation is a max pooling operation.

13. The image processing system of claim 11, wherein the binary image clustering algorithm is a connected-component labeling (CCL) algorithm.

14. The image processing system of claim 11, wherein the image has a height (H) and a width (W) and the grid of binary cells has a height equal to H/K and a width equal to W/K, where K is a kernel size associated with the pooling operation.

15. The image processing system of claim 14, wherein mapping the determined boundaries to the image includes:
upscaling the determined boundaries based on the H and the W of the image.

16. The image processing system of claim 11, wherein the image is a binary motion map of an environment.

17. The image processing system of claim 16, wherein execution of the instructions causes the image processing system to perform operations further including:
capturing a series of images of the environment; and
generating the binary motion map based on changes between two or more images in the series of images.

18. The image processing system of claim 17, wherein execution of the instructions causes the image processing system to perform operations further including:
labeling each of the mapped boundaries as a candidate for object detection.

19. The image processing system of claim 11, wherein execution of the instructions causes the image processing system to perform operations further including:
cropping portions of the image that are bounded by the mapped boundaries; and
performing one or more image processing operations on each of the cropped portions of the image.

20. The image processing system of claim 19, wherein the one or more image processing operations includes an object detection operation.
